(19) United States
(12) Patent Application Publication
(10) Pub. No.: US 2008/0256176 A1
(43) Pub. Date: Oct. 16, 2008

(54) Internet radio system and the broadcasting method thereof

(76) Inventor: Kuo-Hsiu Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,282

(22) Filed: Jan. 9, 2008

(30) Foreign Application Priority Data
Apr. 13, 2007 (TW) 96113120

(51) Int. Cl. G06F 15/16

(52) U.S. Cl. 709/203

(57) ABSTRACT

An Internet radio system includes: several network radio receivers connecting to the Internet, and they transmitting service requests and user's information, then receiving audio data corresponding the service requests, wherein each network radio receivers has its own identification; and a server connecting to the Internet to identify the identification of network radio receiver. The server may store some advertisement information for users to select and display them on the radio receivers.

### BACKGROUND OF THE INVENTION

1. Field of the Invention

The present invention generally relates to a radio system, and more particularly relates to an Internet radio system and the broadcasting method thereof.

2. Description of the Prior Art

By the popularity of the wideband, it is a common thing that the Internet is utilized for the user to listen the radio. Today, the Internet is applied in the fields of working, learning, living, recreation and relationship in modern society. It is not only to lead the business model to occur a revolution, but also to speed up the influence on different media and the growth/incline of the market thereby. Recently, from the developing trend of the media, people spend more and more time on the Internet, and less time on other media. Therefore, the media of the Internet grows continuously, and threatens the market of other conventional media.

The digital medium's appearance changes the feature of a certain medium only providing a kind of information. Nowadays, every medium has the capability to provide the multimedia data and it's content. The digital medium becomes a digital content provider (DCP), and its output data may be broadcasted out and received by various digital terminals.

Currently, a kind of personal computer utilizes an Internet radio software that can receive and broadcast from/to the global Internet radio, it embeds thousands of radios including a lot of Chinese radios, American radios, Japanese radios, French radios, German radios, Singaporean radios, Canadian radios, Korean radios and other international famous radios. Besides, the Internet radio software owns online update function automatically to download the latest information with high data rates.

However, the Internet radio software must be used at the platform of the computer, and it cannot be carried portably to access the service of the radio by login the Internet for anyone at anytime and anyplace. Meanwhile, it is a fast learning way to the users, who receive the information by ears. The modern people always using eyes to work, recreation and reading and so as to degrade the function of their eyes. Therefore, the feature of radio still exists until now for receiving the information.

### SUMMARY OF THE INVENTION

In order to solve the aforementioned problems, one object of the present invention is to provide an Internet radio system, which utilizing a network radio receiver connected to the Internet radio broadcasting system. Therefore, an online community of the Internet radio broadcasting system can be carried portably for the users to listen.

In order to solve the aforementioned problems, one object of the present invention is to provide an Internet radio system, which utilizing a data provider-management module to connect with an Internet radio or a personal digital content provider for broadcasting information. And, a search engine can search the Internet radios to generate a connecting directory and store in a digital content database for the users to look up and search their favorite Internet radios.

In order to solve the aforementioned problems, one object of the present invention is to provide an Internet radio system, which utilizing a server to store the advertisements for the users to select freely.

Accordingly, one embodiment of the present invention provides an internet radio system, which includes: several data-providing apparatuses connecting to the Internet, transmitting the audio files or streaming the audio data to the Internet; a server connecting the Internet, wherein the server recognizes the network radio receivers by identifying the identifications, and the users of the network radio receivers input the users' information to the server via the network radio receivers after logining, and the server provides the users with storing at least one advertisement information.

Accordingly, one embodiment of the present invention provides an Internet information processing server recognizing several network radio receivers by identifying their identifications after logining, receiving users' information of an individual via the network radio receivers, and providing the users at least one stored advertisement information, which includes: a user management module receiving the users' information from the Internet to acquire the users' information; a data provider-management module receiving the audio data and transmitting by the data provider from the Internet, the data provider-management module managing the data providers to acquire the data and the channel information from the data providers; a search engine module searching the network radio stations from the Internet and generating a radio connecting directory; a security management module connecting with the user management module, the data provider-management module and the search engine module to provide a secured protection system for verifying the channel information and the radio connecting directory; and a digital content management module connecting to the security management module to store the channel information and the radio connecting directory.

Accordingly, one embodiment of the present invention provides a broadcasting method of the Internet radio station including the steps of: a server receiving a user's information from the Internet for user management, wherein the user's information is transmitted from a network radio receiver; the server processing and providing the users with storing an advertisement information for user's selection; the server connecting to the network radio station via the Internet, and the audio data of the network radio station streams to the network radio receiver for the user listening to the broadcasting from the network radio station; and if the user having chosen the advertisement information already, the radio management server transmitting the advertisement information to the user after logining, thus the user can listen to the content of advertisement.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating an Internet radio system in accordance with one embodiment of present invention;

FIG. 2 is a schematic diagram illustrating an Internet radio system in accordance with one embodiment of present invention; and

FIG. 3 is a flowchart diagram illustrating steps of the Internet radio stations broadcasting method according to one embodiment of present invention.

### DESCRIPTION OF THE PREFERRED EMBODIMENT

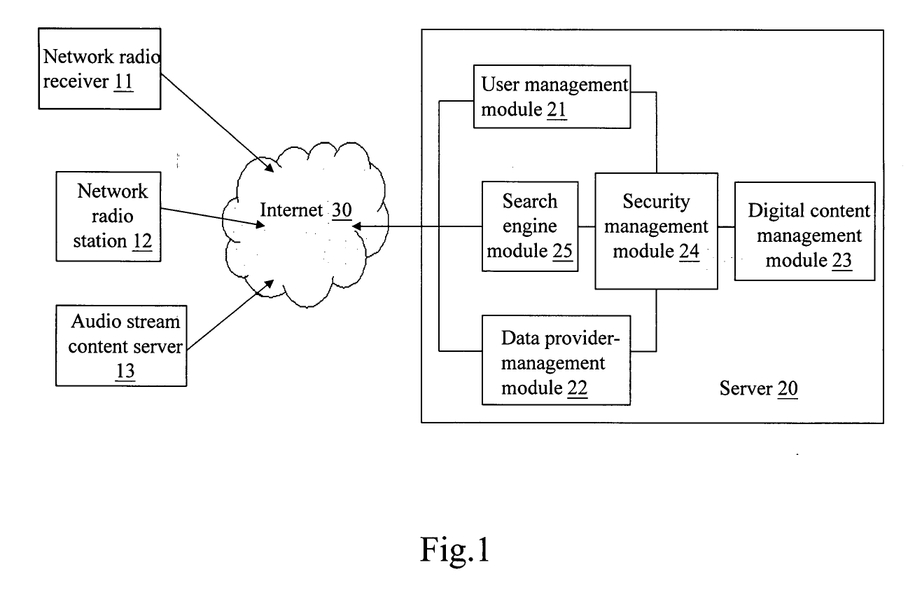

FIG. 1 is a schematic diagram illustrating an Internet radio system in accordance with one embodiment of present invention. In one embodiment, the basic structure of the Internet radio broadcasting system includes a network radio receiver 11 connecting with the Internet 30 to transmit all kinds of service requests and the users' information. Finally, the audio data, the service requests and the users' information are transmitted through the Internet 30 and received by a server 20.

The server 20 also connects to the Internet 30 to identify the network radio receiver 11. The network radio receiver 11 has an input unit for users to login the server 20 thereby. Next, the users may input their users' information via the network radio receiver 11. The server 20 may store one or more advertisement information for users to select and display them on the radio receivers, wherein the network radio receiver 11 has identification, which may be a MAC address. Besides, a personal computer (not shown in the figure) is linked with the Internet 30 to access the advertisement information from the server 20 to display thereon.

Furthermore, the server 20 has a user management module 21 to receive the service requests and users' information transmitted by the network radio receiver 11 via the Internet 30. Meanwhile, the users' information can be managed to acquire the users' age, the listening duration, the songs and the radios being listened and so on. In addition, the server 20 may analyze, classify and manage those users' information to obtain the listeners' information, for example, displaying the fees, the listening characters/habits of the users, the distribution of radio population statistics and the spending time statistics for listening music, etc.

Once, the users login the server 20 into the secured protection system of a security management module 24, so as to access audio data and the radio connecting directory in a digital content management module 23 after passing verification, or connect a channel that is established by the user management module 21 to response the service requests from the network radio receiver 11.

Wherein, the radio connecting directory is searched by a search engine module 25 through the Internet 30 with a network radio station 12 connection. Finally, all connecting directories in the radio station are generated and passed the verification to store in the digital content management module 23 via the secured protection system of the security management module 24 for providing the radio information and the function of connecting the network radio receiver 11 thereby.

Next, an audio stream content server 13 and the network radio station 12 works as a data-providing apparatus. Therefore, the broadcasting information from the radio station of the network radio station 12 is streamed into the data provider-management module 22 in the server 20 for managing the radio stations effectively. Meanwhile, a personal digital content provider may also be set up with the audio stream content server 13 by itself to connect with the Internet 30 for accessing into the data provider-management module 22. Finally, the security management module 24 provides the audio data of the broadcasting content from the data provider, and connects and streams to the digital content management module 23 for accessing to the network radio receiver 11. Each module mentioned above includes a circuitry (maybe a memory included), or further includes software, to process its target job.

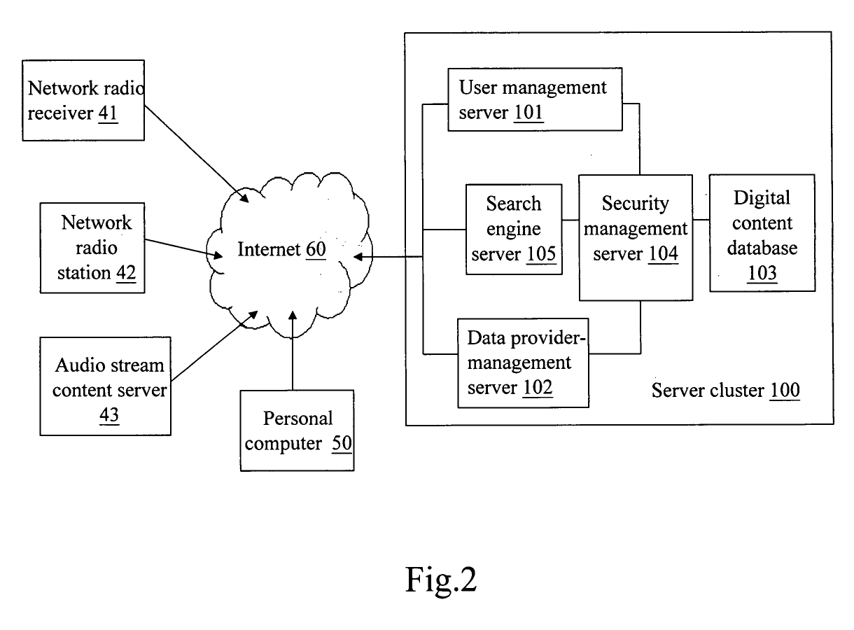

FIG. 2 is another schematic diagram illustrating an Internet radio system in accordance with one embodiment of present invention. A server cluster 100 includes a user management server 101, a data provider-management server 102, a search engine server 105, a security management server 104 and a digital content database 103. The embodiment of FIG. 2 shows the independent and interconnecting servers to achieve the core of the Internet radio broadcasting system to illustrate the each module from the exemplary embodiment of the FIG. 1. In one embodiment, every server may also execute one or several modules to perform the spirit of the present invention.

Accordingly, a network radio receiver 41 connects with an Internet 60 to transmit the service requests and the users' information to the Internet 60 and receives for responding the audio data thereby. The broadcasting information of the radio station from a network radio station 42 streaming into the data provider-management server 102 of the server cluster 100 via the Internet 60 is for managing the radio stations effectively. Moreover, the personal digital content provider may also be set up with an audio stream content server 43 by itself to connect to the Internet 60 for accessing to the data provider-management server 102. Finally, the security management server 104 streams the audio data of the broadcasting information from the digital content database 103 to the network radio receiver 41, wherein the broadcasting information is provided by the data provider.

Meanwhile, the user management server 101 can acquire the users' age, the listening duration, the listening music, the listening radios, and so on. In addition, the digital content database 103 may analyze, classify and manage those users' information to obtain useful information, for example, displaying the fees, the listening characters/habits of the users, the distribution of radio population statistics and the spending time statistics for listening music, etc. Besides, if the users have chosen the advertisement information already, the user management server 101 may transmit the advertisement information to the user after logining. And, the advertisement information is presented by voice or message.

In addition, a personal computer 50 linked to the Internet 60 may also login the server cluster 100, which has the same function as the network radio receiver 41 to utilize the connecting service of the Internet radio or as one-member of the online community provided from the server clusters 100. Moreover, a search engine server 105 may search the Internet radios to generate a connecting directory and store in the digital content database 103 for the users to look up and search for their favorite Internet radios. Besides, the personal computer 50 is linked to the Internet 60 to access the advertisement information from the server cluster 100 to display thereon.

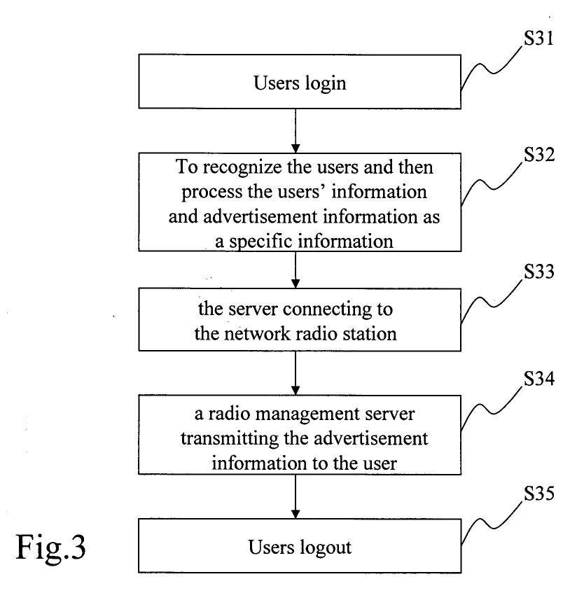

FIG. 3 is a flowchart diagram illustrating steps of the Internet radio stations broadcasting method according to one embodiment of present invention. The steps are: at the step S31, the users login, a server receiving a user's information from the Internet for user management, and the user's information is transmitted from a network radio receiver; at the step S32, recognizing the users and processing the users' information, and the server processes users' information and stores the advertisement information, so as to select the advertisement information freely for the users thereby; at the step S33, the server connecting to the network radio station, and the audio data of the network radio station streams into the network radio receiver; at the step S34, a radio management server transmitting the advertisement information to the users after they login, thus the user can listen to the content of advertisement; at the step S35, the users logout, the radio management server stopping the service for the users, and the listening duration, the listening songs, the fees and other information are transmitted back to the network radio receiver.

The step S31 only depicts the status during users logining. If the users are not the first time to login the radio management server, and the radio management server may transmit the last listening time, song types and other broadcasting information to the network radio receiver. Therefore, the users receive different information from last time logining. Besides, a personal computer can be linked to the Internet to access the advertisement information from the radio management server to display thereon.

To make a brief summary, the present invention may create a community of radio broadcasting from an online community to make the network radio receiver in the online community under the group broadcasting. The identification of the network radio receiver only provides the broadcasting service for the specific members in the online community. Moreover, the original network radio station must provide the members to listen under the secured protection system of the present invention for executing the individual broadcasting, the localized group broadcasting or the union broadcasting.

Next, the present invention not only has the ability to manage the radio stations, but also has; the private broadcasting service in the online community. Furthermore, the members in the online community may be controlled by the secured protection system to avoid the harmful information from being released.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An Internet radio system comprising:
a plurality of data-providing apparatuses connecting to the Internet, transmitting a plurality of audio files or streaming a plurality of audio data to the Internet, wherein the data-providing apparatuses comprises:
at least one network radio station connecting to the Internet and broadcasting the audio data in accordance with a broadcasting program sheet, wherein any of the audio data streamed is received by any of the network radio station server via the Internet; and
at least one audio stream content server connecting to the Internet, storing the audio files therein, wherein any of the audio files is accessed via the Internet; and
at least one server connecting the Internet, wherein the server recognizes a plurality of network radio receivers by identifying their identifications, and the users of the network radio receivers input the users' information to the server via the network radio receivers after logining, and the server provides the users with storing at least one advertisement information;
wherein, the server receives the audio data or the audio files to transmit from any of the data-providing apparatus, and any of the data-providing apparatus acquires a plurality of data providers' information or at least one channel information.

2. The Internet radio system according to claim 1 further comprising a plurality of network radio receivers connecting to the server via the Internet, transmitting at least one users' information to the server, and receiving at least one audio data from the server, wherein each of the network radio receiver has an identification.

3. The Internet radio system according to claim 2, wherein each network radio receiver comprises an input unit to login the server.

4. The Internet radio system according to claim 2, wherein each of identification is a MAC address.

5. The Internet radio system according to claim 1, wherein the server receives the users' information by analyzing/classifying/processing to display the fees, the listening characters/habits, the distribution of radio population statistics and the spending time statistics for listening music.

6. The Internet radio system according to claim 1, the users have chosen the advertisement information already, the server transmits the advertisement information to the users after logining.

7. The Internet radio system according to claim 1, wherein the advertisement information is presented by voice.

8. The Internet radio system according to claim 1, wherein the users' information comprise the users' age, the listening duration, the songs and the radios being listened.

9. The Internet radio system according to claim 1 further comprising a personal computer being linked with the Internet to access the advertisement information from the server to display thereon.

10. An Internet information processing server, recognizing a plurality of network radio receivers by identifying their identifications after logining, receiving users' information of an individual via the network radio receivers, and providing the users at least one stored advertisement information, wherein the server comprises:
a user management module receiving the users' information from the Internet to acquire a plurality of users' information;
a data provider-management module receiving a plurality of audio data and transmitting by the data provider from the Internet, the data provider-management module managing the data providers to acquire the data and at least one channel information from the data providers;
a search engine module searching the network radio stations from the Internet and generating a radio connecting directory;
a security management module connecting with the user management module, the data provider-management module and the search engine module to provide a secured protection system for verifying the channel information and the radio connecting directory; and
a digital content management module connecting to the security management module to store the channel information and the radio connecting directory;
wherein, the server receives the audio data or the audio files and transmits from any of the data provider, and each data provider acquires a plurality of data providers' information or at least one channel information.

11. The Internet information processing server according to claim 10, wherein the server receives the users' information by analyzing/classifying/processing to display the fees, the listening characters/habits of the users, the distribution of radio population statistics and the spending time statistics for listening music.

12. The Internet information processing server according to claim 10, the users have chosen the advertisement information already, and the server transmits the advertisement information to the users after logining.

13. The Internet information processing server according to claim 10, wherein the advertisement information is presented by voice.

14. The Internet information processing server according to claim 10, wherein the users' information comprise the users' age, the listening duration, the songs and the radios being listened.

15. The Internet information processing server according to claim 10, wherein each data provider is an Internet radio.

16. The Internet information processing server according to claim 10, wherein the data provider builds a channel to stream the audio data of the Internet radio to the network radio receivers.

17. The Internet information processing server according to claim 10, wherein the security management module stores a plurality of digital audio data.

18. The Internet information processing server according to claim 10, wherein the data provider builds a channel to stream the digital audio data to the network radio receivers.

19. The Internet information processing server according to claim 10 further comprising a personal computer being linked with the Internet to access the advertisement information from the server for displaying thereon.

20. A broadcasting method of the Internet radio station comprising the steps of:
(a) a server receiving a user's information from the Internet for user management, wherein the user's information is transmitted from a network radio receiver;
(b) the server processing and providing a user with stored advertisement information for the user's selection;
(c) the server connecting to the network radio station via the Internet, and the audio data of the network radio station is streamed to the network radio receiver for the user to listen to the broadcasting from the network radio station; and
(d) if the user having chosen the advertisement information already, the server transmitting the advertisement information to the user after the user's logining, thus the user can listen to the content of advertisement.

21. The broadcasting method of the Internet radio stations according to claim 20, wherein the server processes the users' information to display the fees, the listening characters/habits of the users, the distribution of radio population statistics and the spending time statistics for listening music.

22. The broadcasting method of the Internet radio stations according to claim 20, wherein the advertisement information is presented by voice.

23. The broadcasting method of the Internet radio stations according to claim 20, wherein the users' information comprises the users' age, the listening duration, the songs and the radios being listened.

24. The broadcasting method of the Internet radio stations according to claim 20 further comprising: (e) when the users being logout, the radio management server stopping the service to the users, and then transmitting the listening time, the listening songs, the fees and other information to the network radio receiver.

25. The broadcasting method of the Internet radio stations according to claim 20, wherein the radio management server issues the advertisement information on the Internet further comprising a personal computer linked the Internet to access the advertisement information from the radio management server to display thereon.
